(19) United States
(12) Patent Application Publication
(10) Pub. No.: US 2006/0090722 A1
(43) Pub. Date: May 4, 2006

(54) Intake manifold spacer for an internal combustion engine

(76) Inventor: John Boveia, North Little Rock, AR (US)

Correspondence Address: John Boveia, 304 Smokey Lane, North Little Rock, AR, 72117, US

(21) Appl. No.: 10/980,249

(22) Filed: Nov. 4, 2004

(51) Int. Cl. F02M 35/10

(52) U.S. Cl. 123/184.21; 123/184.61

(57) ABSTRACT

A device for use in a sectional intake manifold of an internal combustion engine which includes a body portion having an upper surface and a lower surface. The body portion includes a passage surface defining one passage about an axis from the upper surface to the lower surface. The passage surface provides an opening which is in fluid connection with the sections of the intake manifold and which is sealed to such sections using an O-ring or flat style gasket, based upon the application. Once the device is installed in the sectional intake manifold, it increases the overall plenum volume thereby enhancing the performance and efficiency of the internal combustion engine.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### FIELD OF INVENTION

The present invention relates generally to air intake manifolds for internal combustion engines, and more specifically to an add-on modification to such air intake manifolds providing improved power and torque over a wide range of engine speeds for multi-cylinder four-stroke internal combustion engines.

### BACKGROUND OF THE INVENTION

Air intake manifolds for internal combustion engines generally comprise a manifold body formed with a common chamber having an inlet connected to an air or throttle valve and an exit connected to a combustion chamber. Many intake manifold bodies are constructed by utilizing convexly formed sections which, when assembled and properly sealed, form a defined manifold air chamber, or plenum. In some cases, a number of air passages or runners are formed within, or in close proximity to, the plenum itself, Such passages or runners have an inlet at the plenum interior and an outlet connected to one of the cylinders of the engine in one compact and modular intake manifold unit. In other cases, the plenum and runners are separate but connected to one another to comprise a complete air intake manifold unit.

In operation, a “dry” intake manifold utilizes a flow of air that is directed through the air intake inlet into the plenum. Once the air is taken into the plenum, it is then distributed into the several runners for transmission to the cylinders of the engine where it is then intermixed with fuel supplied by fuel injectors located in close proximity of the combustion chamber.

Air-fuel intake manifolds, or “wet” intake manifolds, are generally similar in construction except the air inlet is connected to a fuel injection or carburetion system which discharges a mixture of fuel into the air as it passes into the plenum for distribution to the passages or runners. The runners then exit at inlet ports at each cylinder, where the inlet valves in the combustion chamber control the passage of air through the ports into the cylinders for combustion.

All air intake manifolds take in air through an air, throttle or metering valve (hereinafter “air valve”) driven by an internal vacuum. This vacuum results from a suction created by the downward movement of the piston inside the combustion chamber. The air valve attached to the intake manifold controls the amount of air available to be drawn into the plenum. This vacuum and air intake balance, generally referred to as pressure differential, is absolutely critical to the performance of the internal combustion system and, without such, the engine will not operate.

The prior art has made substantial efforts toward increasing the amount and velocity of air, or air/fuel mixture, drawn into the cylinder during the intake cycle. The first category of such developments center upon mechanical add-on devices such as superchargers that are driven off the camshaft or crankshaft of the engine, or turbochargers that are driven by the force of the exhaust gases. Both are designed to be in a fluid connection with the existing intake manifold and to artificially force more air, or air/fuel mixture, through the intake valve, and into the plenum and runner system for increased volume injected into the cylinder. Historically, these mechanical add-on devices add considerable cost and complexity to the engine, with the supercharger normally being ineffective at lower operational ranges, and the turbocharger restricting the natural flow of exhaust gases throughout the range of operation.

The second class of improvement is related to the actual configuration and “tuning” of the intake manifold structure itself. In general, tuned intake manifolds utilize the pressure waves in the intake air and those in the exhaust created by rapid piston movement. This process augments intake by tuning the waves to be substantially in phase with the desired directions of movement combustion air, or air/fuel, to the cylinder.

Extensive research and design have gone into the development of specific shaped and tuned intake manifolds. For example, U.S. Pat. No. 4,461,248, issued Jul. 24, 1984, describes an example of a central plenum intake manifold designed for broad torque band application. U.S. Pat. No. 5,505,170, issued Apr. 9, 1996, demonstrates an air intake manifold with a plenum formed, in part, by a convexly curved floor. U.S. Pat. No. 5,632,239 describes an example of a conventional intake manifold for a V-6 engine while U.S. Pat. No. 6,802,292 demonstrates an intake manifold for a V-type engine containing three plenums in fluid connection with one another. As demonstrated by the various prior teachings, intake manifold solutions have not been simple to implement and require a high level of sophistication on the part of the manifold designer. Regretfully, once the manifold design is manufactured and installed, its dimensions and capacity cannot be changed, save the total replacement of the intake manifold itself.

As previously mentioned, an air valve serves as the sole inlet for air drawn into the intake manifold. The air valve is adjustable through the use of a throttle plate or other restrictive device and regulates the air volume taken into the manifold. The intake of air is, therefore, restricted by the size and configuration of the air opening, and the degree of opening of the adjustable valve. Therefore, despite the exhaust driven needs of the engine in operation, the supply of air is directly related to, and restricted by, the air valve intake capacity. Many existing internal combustion engines lack adequate performance and efficiency because they are starved for air, or a/fuel mixture, and an inadequate reserve within the intake manifold to address this need.

In attempt to solve this problem, various devices have been developed for use in the intake path of the internal combustion engine to increase the intake velocity and capacity. By way of example, in-line spacer devices are described in U.S. Pat. No. 4,086.899 entitled “Air Fuel Inlet Device for Internal combustion Engines”, issued May 2, 1978; U.S. Pat. No. 3,645,243 entitled, “Fuel Mixing and Vaporizing Device for Internal Combustion Engines,” issued Feb. 29, 1972; and, “Intake Device for Use with Internal Combusion Engines”, issued Jan. 9, 2001. All of these devices, and others known to those familiar with the art, are for use between the air valve, and the inlet portion of the intake manifold structure itself. The stated purpose of such devices is to increase the velocity of the air-fuel mixture, to provide a more complete mixture of fuel and air, or to induce a swirl motion to turbinate the air upon entry into the intake manifold itself. Regretfully, while these devices assist to increase the flow characteristics of the air inlet, the configuration of such devices is dependent upon the air intake dimensions of the intake manifold itself and they do increase the volume capacity of the plenum within the intake manifold. Therefore, these devices do no address the need for an increased reserve of air, or air/fuel mixture, in close proximity to the combustion chamber.

As demonstrated by the multitudes of intake manifold and air inlet designs, it has become readily apparent that many internal combustion engines require an increased supply of instantly available air, upon demand, and as driven by the exhaust function of the engine. Such demand cannot be adequately addressed with existing devices because the atmospheric air supply cannot be injected into the engine at any greater speed than allowed by the intake manifold structure itself, unless a turbocharger or supercharger are added. Even then, the supply of readily available air, or air/fuel mixture, located in the plenum chamber is not increased to allow a more available supply to the engine.

With the advent of consumer needs to increase the overall performance and efficiency of the internal combustion engine, while the above developments and devices provide enhancements to the quality and quantity of air available in the intake point of the intake manifold, they do not provide for the increase in overall retained volume of such induced air within the confines of the intake manifold.

The present invention addresses these recognized needs and is described in more detail herein

### BRIEF SUMMARY OF THE INVENTION

The present invention, as described below, addresses the referenced deficiencies herein described and other problems that will become apparent to one skilled in the art. Generally, the present invention provides a spacer for insertion into a multi-section intake manifold of an internal combustion engine which improves engine performance, decreases fuel consumption, and may result in more low-end torque, more horsepower and other various functions which will become apparent from the description below.

A devise for use in an intake manifold of an internal combustion engine in accordance with the present invention includes a body portion having an upper surface and lower surface as described below. The body portion further includes one passage surface defining a passage about the axis from the upper surface to the lower surface. The passage is relatively smooth in configuration and is designed to closely match the internal dimensions of the inner and outer surfaces of the intake manifold itself.

It is, therefore, the principle object of the present invention to provide a convenient and inexpensive method and device for addition to existing air intake manifold designs to provide enhanced volume within the plenum chamber of the intake manifold.

Another object of the present invention is to provide additional air capacity to create a free breathing system that adds power and performance at all engine speeds.

An additional feature of the present invention is that it is simple and inexpensive to manufacture, the installation of such is within the experience and expertise of the user, and the cost to performance increase is relatively inexpensive when compared to other available internal combustion engine modifications.

Yet another feature is that the addition of the invention to most engines does not materially increase the overall dimensions of the engine, nor provide undue restrictions to the mechanical function of the vehicle, in either a conventional or transverse mounting.

Also, with the exception of providing additional plenum volume, the present invention does not alter the integral design of the intake manifold, nor does it obstruct the use and benefits of such add-on devices as the supercharger, turbocharger, or air inlet modifications.

Another advantage of the present invention is that it increases power, improves emissions characteristics and reduces fuel consumption.

Other objects, advantages and features of the invention will become apparent from the following detailed description as considered in conjunction with the accompanying drawings.

### BRIEF DESCRIPTION OF THE SEVERAL VIEWS OF THE DRAWING

FIG. 1 is an exploded perspective view showing the manner in which a device according to the present invention is positioned between the upper and lower intake manifold sections of an internal combustion engine having a fuel injection system.

FIG. 2 is a detailed bottom perspective view of a device according to the present invention.

FIG. 3a is a top view of a device according to the present invention

FIG. 3b is a bottom view of a device according to the present invention.

### DETAILED DESCRIPTION OF THE INVENTION

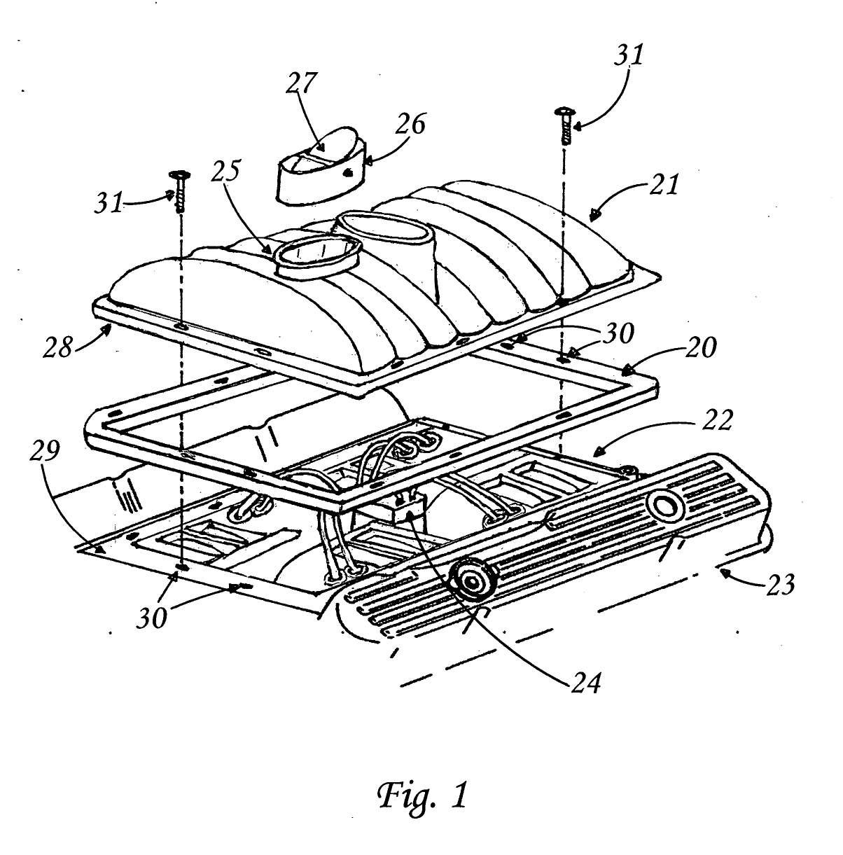

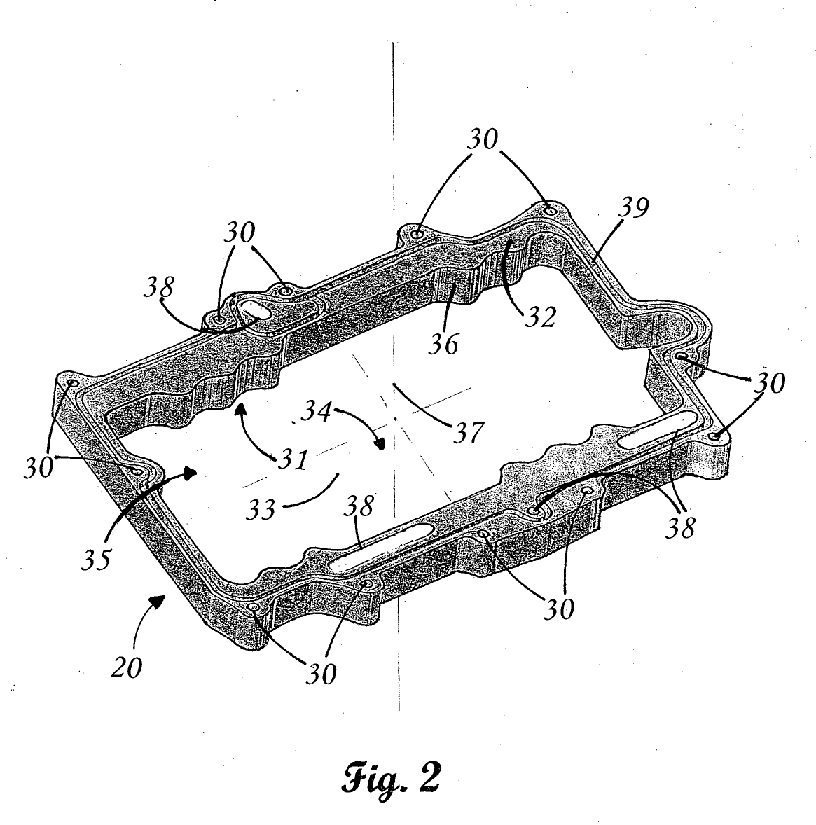

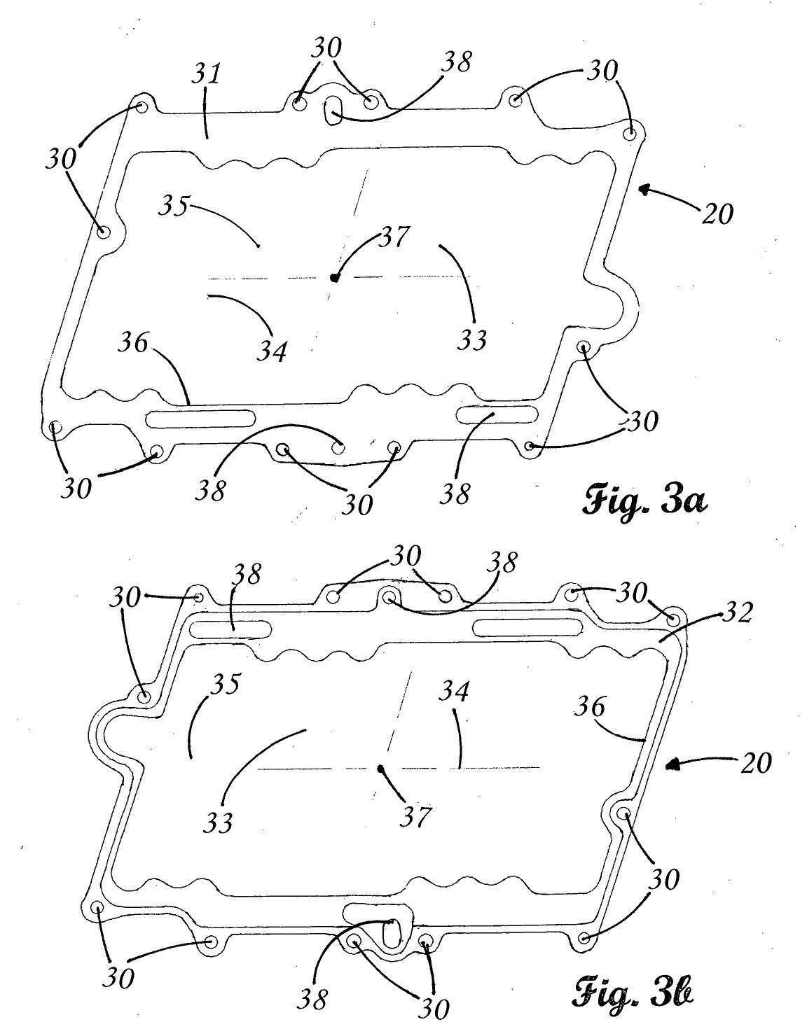

The present invention shall generally be described with reference to FIGS. 1, 2, 3a and 3b. FIG. 1 is an exploded perspective view showing the manner in which a device according to the present invention is positioned between the upper and lower intake manifold sections of an internal combustion engine having a fuel injection system. FIG. 2 is a detailed perspective view of a device according to the present invention. FIGS. 3a and 3b are top and bottom views of a device according to the present invention, as also depicted in FIG. 2.

One skilled in the art will recognize that the spacer device shown in FIGS. 1, 2, 3a, and 3b may be a part of any device (e.g. spacer, adaptor, riser, etc) for use with the intake manifold in any internal combustion engine. For example, such devices may be used in an intake manifold used with either a carburetor, throttle body injectors, or direct injectors in various applications such as trucks, automobiles, tractors, etc. As will become apparent from the description below, the various embodiments and configurations described herein may be used in one or more combinations, and the present invention is not restricted to any particular illustrative example shown in the drawings.

For example, the configuration shown in FIGS. 2, 3a and 3b are based upon the design and specifications of the upper and lower portions of the intake manifold as used in a typical V-configuration internal combustion engine. It will further be understood to one skilled in the art that the teachings of the present invention are generally applicable to any air intake manifold system of an internal combustion engine that consists of a top and bottom section, or other sectional configuration that allows insertion of the device.

FIG. 1 illustrates the use of a device 20 positioned between the upper half 21 and lower half 22 of an intake manifold of an internal combustion engine 23. The intake manifold, consisting of both the upper and lower half, includes a direct fuel injection system 24, which injects fuel in close proximity to each cylinder in a predetermined order. In the absence of the device, the upper and lower portions of the intake manifold join to form a common plenum and related structures directing the air charge into the cylinders of the internal combustion engine. Pursuant to the manufacturer's design, the common plenum and related structures contain a predetermined volume capacity. After the addition of the device, this volume will be increased in the range of 23 to 35 percent, depending upon the configuration and tolerances of the intake manifold. The volume increase can be adjusted by varying the thickness of the medium from which the spacer is made.

The top portion of the intake manifold contains an air inlet 25 allows air to enter the plenum chamber. This air inlet communicates directly with an air-metering device 26 that contains a throttle plate 27 to control the air volume allowed to enter the air inlet.

The configuration of the device conforms generally with the base of the top portion of the intake manifold 28 and the corresponding surface of the bottom portion of the inlet manifold 29. When positioned between the top and bottom portions of the intake manifold, the passage defined in the devise aligns axially with the relative openings. A plurality of holes 30 are defined through the device and positioned to accommodate the bolts 31 which connect the top portion of the intake manifold 21 with the bottom portion of the intake manifold 22. The placement of these holes varies according to the intake manifold's specifications.

It has been discovered that when the spacer 20 is configured and dimensioned in accordance with the teachings of the invention, significant increases in engine efficiency and performance are obtained, with corresponding reductions in exhaust emissions. For example, once the spacer is inserted between the upper and lower portions of the intake manifold, and compressed to form an airtight seal, the internal combustion engine will experience a horsepower increase of approximately 10% and a rear wheel torque increase of approximately 8%. In addition to the performance enhancement, the internal combustion engine will also experience an 8% to 12% gain in fuel efficiency.

FIG. 2 is a bottom view perspective of an embodiment of the invention configured to fit an intake manifold as used by General Motors in a 5.7 Liter Vortec V-8 engine. This engine utilizes a two part intake manifold system, comprised of an upper intake manifold section 21 and a lower intake manifold section 22, as shown in FIG. 1. The intake manifold also houses a central core fuel injection system which distributes un-mixed gas in close proximity of the combustion chamber. This embodiment is not restrictive and the invention is adaptable to most internal combustion engines which utilize a multi-part intake manifold system.

The spacer 20, as an example, is constructed of billet aluminum material that may vary in thickness from 0.75″ to 3.00″. Such spacer may also be constructed of other materials such as plastic, rubber, phoenelic resin, metal, etc. The length, width, and detail of the design will vary depending on the application.

The spacer 20 has a defined upper surface 31 and lower surface 32; such surfaces being parallel to one another. The passage 33 includes an inlet opening 34 defined at the upper surface of the spacer body and an outlet opening 35 defined at the lower surface of the spacer. Generally, the size of the inlet opening and outlet opening may vary depending upon corresponding intake manifold path structures, and the openings defined therein.

A passage surface 36 defines the passage about an axis 37 from the upper surface 31 of the spacer body to the lower surface 32 of the spacer body. The passage surface is a continuous surface from the upper surface of the spacer body to the lower surface of the spacer body. The passage surface may be smooth, textured, or etched in finish quality.

A plurality of holes 30 are defined through the device and positioned to accommodate the bolts which connect the top portion of the intake manifold 21 with the bottom portion of the intake manifold 29, as further described in FIG. 1, herein. The placement of these holes varies according to the intake manifold's specifications. Utilizing existing or purchased hardware, the spacer 20 will be positioned using existing mounting holes of an intake manifold for the internal combustion engine.

A plurality of openings 38 are likewise defined through the device and positioned to accommodate the inlet and outlet ports in the top and bottom portion of the intake manifold. These openings accommodate pass-through air and suction flow in the upper and lower sections of the intake manifold. Alignment and seal of these openings is necessary with the placement of these openings in the spacer dictated by the intake manifold's specifications. In addition, an optional U-shaped grove 39 defined in either the upper or lower surface of the spacer, or both, is added to receive an O-ring type rubber insert that forms a seal of the spacer to the intake manifold sections.

FIG. 3a is a top view of a spacer according to the present invention, and designed to fit an intake manifold as described in FIG. 2, herein. FIG. 3b shows the same device but viewed from the bottom. There are no dimensional differences between the two devices, with the exception that FIG. 3b demonstrates the addition of an optional U-shaped grove in the bottom of the spacer to accommodate an O-ring gasket. This U-shaped grove may also be inserted in the top of the spacer, depending upon the application.

The spacer 20, as an example, is constructed of high quality billet aluminum material that may vary in thickness from 0.75″ to 3.00″. Such spacer may also be constructed of other materials such as plastic, rubber, phenolic or similar resin, metal, etc. The length, width, and detail of the design will vary depending on the application. The spacer 20 has an upper surface 31 and lower surface 32, both of which define a passage 33 comprised of an inlet opening 34 and an outlet opening 35. Generally, the size of the inlet and outlet opens may vary depending upon corresponding intake manifold path structures, and the opening dimensions defined therein.

A passage surface 36 defines the passage about an axis 37 running from the upper surface 31 of the spacer body to the lower surface 32 of the spacer. The passage surface is a continuous surface from the upper surface of the spacer body to the lower surface of the spacer body, with the depth of such passage surface dictated by the thickness of the spacer medium.

A plurality of holes 30 are defined through the device and positioned to accommodate the bolts which connect the top portion of the intake manifold with the bottom portion of the intake manifold, as further described in FIG. 1, herein. The placement of these holes varies according to the intake manifold's specifications. Utilizing existing or purchased hardware, the spacing block 20 will be positioned using existing mounting holes of an intake manifold for an internal combustion engine.

A plurality of openings 38 are defined through the device and positioned to accommodate the inlet and outlet ports in the top and bottom portion of the intake manifold that accommodate air and vacuum flow in the intake manifold design. The placement of these openings is likewise dictated by the intake manifold's specifications.

The device is installed using a gasket form cut to the specifications of the spacer device. The footprint of this gasket will correspond to the dimensions of the spacer, as shown in FIGS. 3a and 3b. The gasket will contain bolt holes 30 and cutouts for openings 38 which likewise correspond to the holes and openings found in the upper and lower sections of the intake manifold application. An alternative method for installing a gasket is shown in FIG. 3b. This gasket is formed by the insertion of an O-ring type rubber insert into a U-shaped grove 39 defined in either the upper or lower surface of the spacer, or both. When installed using either variety of gasket, the spacer serves to separate the upper and lower sections of the intake manifold with the overall design depending upon the configuration and specifications of the intake manifold.

The preceding specific embodiments are illustrative of the practice of the invention. It is to be understood, therefore, that other expedients known to those skilled in the art or disclosed herein may be employed without departing from the invention or the scope of the appended claims. For example, a device according to the present invention may include or incorporate any number of the illustrative configurations as described herein, or the exterior or interior dimensions of the device may vary dependent upon the design characteristics of the intake manifold, plenum, fuel injection devices and locations, or other variations commonly encounter in internal combustion engines. As such, the present invention includes within its scope other methods of implementing and using the invention described herein above.

1. A spacer device for use in an internal combustion engine which is adapted to be positioned and sealed between the sections of either a carburetor or fuel injection type intake manifold.

2. The device of claim 1, wherein the body portion of the spacer contains holes and openings to accommodate the bolt and airway passages of the intake manifold application.

3. The device of claim 2, wherein the body portion of the spacer contains a U-shaped groove in either the lower surface region or the upper surface region, or both, and which accepts a continuous O-ring style gasket.

4. A device for use in an internal combustion engine which is adapted to be positioned and sealed between the sections of either a carburetor or fuel injection type intake manifold, the device comprising;
(a) a body portion having an upper surface region and a lower surface region;
(b) a passage surface defining a passage about an axis from the upper surface region to the lower surface region through the body portion, where the passage has an inner circumference which is defined by the dimensions of the application.

5. The device of claim 4, wherein the body portion of the spacer contains holes and openings to accommodate the bolt and airway passages of the intake manifold application.

6. The device of claim 5, wherein the body portion of the spacer contains a U-shaped groove in either the lower surface region or the upper surface region, or both, and which accepts a continuous O-ring style gasket.
